(19) United States
(12) Patent Application Publication
(10) Pub. No.: US 2024/0099345 A1
(43) Pub. Date: Mar. 28, 2024

(54) Food Compounds Infused Consumables

(71) Applicant: Michael William Randel, Lakebay, WA (US)

(72) Inventor: Michael William Randel, Lakebay, WA (US)

(21) Appl. No.: 17/953,248

(22) Filed: Sep. 26, 2022

(51) Int. Cl. A23L 27/00; A21D 13/00; A23D 9/04; A23F 5/14; A23F 5/48; A23G 1/30; A23G 9/32; A23L 7/10; A23L 7/126; A23L 11/00; A23L 19/00; A23L 21/10; A23L 25/00

(52) U.S. Cl. CPC A23L 27/70; A21D 13/00; A23D 9/04; A23F 5/14; A23F 5/483; A23G 1/30; A23G 9/32; A23L 7/126; A23L 7/197; A23L 11/01; A23L 19/03; A23L 21/10; A23L 25/20; A23V 2002/00

(57) ABSTRACT

The present disclosure is directed to whole spectrum compounds from a first food infused into a food grade oil or second food and beverage consumables, along with methods of producing the consumables infused with compounds from the first food. The second food consumables are infused in an overall two-step process, in which compounds from a first food are initially infused into a food grade oil, which in turn is used to infuse a second food and beverage consumable with whole spectrum compounds from the first food.

### CROSS-REFERENCE TO RELATED APPLICATION

This application claims the benefit of U.S. Provisional Application No. 63/248,274 filed on Sep. 24, 2021, which is incorporated by reference in its entirety.

### FIELD OF THE INVENTION

The invention relates to the infusion of flavors, vitamins, and minerals from raw foods and extracts into food grade oil, which in turn is used to infuse a variety of food and beverage consumables.

### BACKGROUND

Infusion is a commonly used method to extract flavors from foods, herbs and the like and transfer them into a liquid. Likewise, flavors from liquids can be infused into foods. Generally, there are two main components to infusions: the liquid or food to be infused, and the flavoring agent. The two components typically are combined together and the flavors from the two meld into each other, resulting in an infused liquid or food. Infusion is typically done by soaking a food in a liquid for a period of time to allow flavors to transfer into the liquid, or to allow flavors to transfer from the liquid to the food. Typically, infused liquids include water, alcohol, oil, vinegar, or milk, whereby the liquid can be hot or cold in the infusion process. Liquids such as broths, marinades, brines, etc. are commonly used to impart flavor to meat and other food as a type of infusion. Likewise, alcohols, vinegars, etc. are often used to infuse foods such as fruit, vegetables, etc. with flavor.

While there is an abundance of food flavoring infusion processes and techniques, some foods are resistant to typical infusion methods. Some infusion methods likewise provide little penetration of flavors into a food. It is also desirable to be able to infuse foods to obtain benefits from other foods, such as health and well-being benefits. Accordingly, there is a need in the art for an improved food infusion process that effectively transfers flavors and various food compounds into other foods. The presently disclosed methods of infusing foods with flavors, vitamins, and minerals from other raw foods and extracts addresses this need.

### SUMMARY

The present disclosure provides for orally ingestible, first food compounds infused food grade oil and infused second food and beverage consumables along with methods of producing such food grade oil and consumables.

The overall method disclosed entails a two-step process in which coconut oil or another food grade oil is first infused with whole spectrum food compounds from a first food. In the second step, the food compounds infused coconut oil or other food grade oil is used to infuse a given consumable second food, to generate a whole spectrum first food compounds infused second food consumable. An infused food consumable, such as coffee beans, can be used to generate a food compounds infused beverage, such as coffee.

In a preferred embodiment, a food grade oil is infused with whole spectrum food compounds. The infusion method includes providing food material/biomass; heating the food material with a food grade oil at a temperature of 170° F.-240° F. for 4-9 hours; freezing the food and food grade oil mixture into a solid frozen biomass; heating the solid, frozen biomass of food material and food grade oil at temperature of 150° F.-240° F. for 2-4 hours to liquify the food grade oil, and straining the food material and food grade oil mixture to separate the food grade oil from the food material to yield food grade oil infused with whole spectrum food compounds.

Once a whole spectrum food compounds infused food grade oil is obtained, the infused food grade oil can in turn be used to infuse consumables/a second food with whole spectrum food compounds. In a preferred embodiment, an orally ingestible consumable is mixed with whole spectrum food compounds infused food grade oil and heated to a temperature of 170° F.-240° F. for 4-9 hours; the consumable and infused food grade oil mixture is then frozen to form a solid, frozen mixture; the mixture is then heated to a temperature of 150° F.-240° F. for 2-4 hours to liquify the infused oil; and the consumable is then strained from the infused oil to yield a consumable infused with whole spectrum food compounds. Preferably, the infused consumable is next frozen prior to subsequent use of the consumable.

The presently disclosed methods can be employed with virtually any type of food that is amenable in the process as either a first, donor food of whole spectrum food compounds or a second, recipient food/consumable that can be infused with food compounds from a first food donor. For example, without limitation, a first, donor food can be obtained from coffee beans, cacao beans, raw nuts and seeds, jalapeno peppers, peppers, raw fruit, garlic, bacon, and combinations thereof. Likewise, without limitation, a second, recipient food can be obtained from coffee beans, cacao beans, tea leaves, raw vegetables, raw nuts and seeds, roasted nuts and seeds, popcorn kernels, corn kernels, potatoes, dehydrated fruit, raw fruit, beans, rice, and noodles.

The presently disclosed food compounds infused food grade oils and consumables are more fully described in the detailed description below.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 shows example steps of a method according to exemplary embodiments hereof.

FIG. 2 shows example steps of a method according to exemplary embodiments hereof.

FIG. 3 shows example steps of a method according to exemplary embodiments hereof.

### DETAILED DESCRIPTION OF EXEMPLARY EMBODIMENTS

The presently disclosed food compounds infused consumables and methods of producing such consumables provide for a wide range of infused food and beverage consumables. These consumables impart desired flavors, qualities, and effects as a result of compounds from a first food that has been infused in the second food consumables.

In general, the presently disclosed methods relate to infusing a food grade oil with whole food compounds from a first food, and then in turn using the infused food grade oil to infuse a second food with whole spectrum food compounds from the first food. In this manner, flavors, vitamins, minerals, and the like can be effectively transferred from a first food to an infused, second food. For example, flavors from jalapeno peppers as a first food can be transferred into infused popcorn kernels as a second food to generate jalapeno flavored popcorn. In particular for this example, coconut oil can be infused with compounds from jalapeno peppers. The jalapeno peppers infused coconut oil is in turn used to infuse popcorn kernels with jalapeno pepper compounds to generate jalapeno flavored popcorn.

In general, the presently disclosed food compounds infused consumables relate to a wide variety of foods and, in some cases, resultant beverages made from the food/consumable that provide a source of compounds from a first food. The presently disclosed consumables are infused with compounds from a first food in a way that provides significant levels and quantities of desired first food compounds transferred to the consumables. The whole spectrum compounds infused from the first food into the consumables can impart desired flavors, vitamins and minerals, health benefits, essence and feeling, and other effects into the consumables.

The food compounds infusion methods described herein can be used to infuse a wide variety of food consumables, which in some instances can in turn be used to make an infused beverage. Virtually any food's material that can be effectively manipulated in the method(s) described herein can be a candidate for a first food or a second food, where whole spectrum compounds from a first food are indirectly infused into a second food. Types of food include those used to infuse flavor, as well as those infused for other effects. For example, foods that are nootropics or “brain boosters” can be employed as natural substances that provide compounds that enhance cognitive performance and work to improve mental function by boosting one's memory, creativity, motivation, and attention. Likewise, plants and herbs that are recognized as adaptogens can be used as infusion donors with the ability to enhance human resilience to stress.

Candidate first foods (compound donors) include essentially all raw foods, such as, but not limited to, coffee beans, cacao beans, raw nuts and seeds, jalapeno and other peppers, raw fruit, garlic, bacon, and the like. In other embodiments, nootropics and adaptogens such as, but not limited to, Ashwagandha, Astragalus, Ginkgo Biloba, Kava, Kratom, Ginseng, Elderberry, Holy Basil, Maca, Goji Berries, Licorice Root, Rhodiola, and Schisandra berry can be applied in the method(s) disclosed herein. Exemplary candidate second foods (infusion/compound recipients) include, but are not limited to, coffee beans, cacao beans, tea leaves, raw vegetables, raw nuts and seeds, roasted nuts and seeds, popcorn kernels, corn kernels (such as those ground and used to make corn chips), potatoes (such as use in potato chips), dehydrated fruit, raw fruit, trail mix, granola bars, beans, rice, noodles, ice cream, jams and jellies, baked goods, and freeze-dried consumables. In one embodiment, candidate second foods include those used to make snack and similar foods, as well foods that are ingredients in a wide variety of end food products.

As used herein, the terms “food compounds infused” or “infused” refers to consumables (second foods) or food grade oil to which whole spectrum compounds from other, first foods or extracts have been infused by a method(s) disclosed herein. Such compounds or molecules include, but are not limited to, flavoring compounds, vitamins, minerals, and the like. The infusion method generally involves preparing a mixture made with food materials (whole or parts of foods) from a first food and a food grade oil, such as coconut oil, under specific heating and cooling conditions to produce whole spectrum first food compounds infused food grade oil. In turn, the first food compounds infused oil, is used to infuse other, second food consumables as detailed herein. Throughout this specification, food compounds infused food and/or drink may be referred to as “first food compounds infused,” “food compounds infused,” or simply “infused,” such as “jalapeno pepper compounds infused popcorn kernels” or “infused popcorn kernels.”

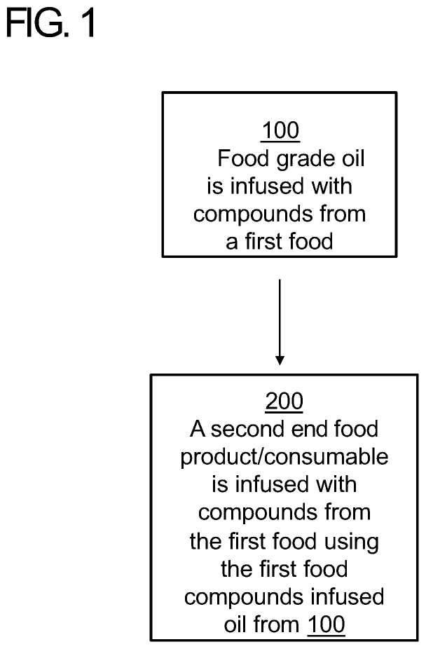

As shown in FIG. 1, the methods disclosed herein provide an overall two-step process by which whole spectrum food compounds from a first food are infused into a second food. In the first step (at 100), a first food material (whole food or part of a food) is used to infuse a food grade oil, such as coconut oil, with whole spectrum compounds from the first food, the compounds including, but not limited to, flavoring compounds, vitamins, minerals, and so forth. Note that because whole food material (whether whole or parts of a food) is used at 100, the resulting infusion of the food grade oil from the food provides a full, whole spectrum of food compounds from the first food to the oil. In a second step (at 200), the infused food grade oil is used to infuse a second, end food product/consumable with whole spectrum compounds from the first food. After the end product is infused with food compounds from the first food, it may be consumed in any typical fashion, such as direct consumption, use as an ingredient, used to make a beverage as in the case of coffee beans, and so forth.

Consumption of the infused food and drink consumables generated by the methods described herein provides desired and/or beneficial effects generally associated with the first food. These benefits include, but are not limited to, food flavoring, vitamins and minerals, and other effects attributed to consumption of a first food used in the infusion process.

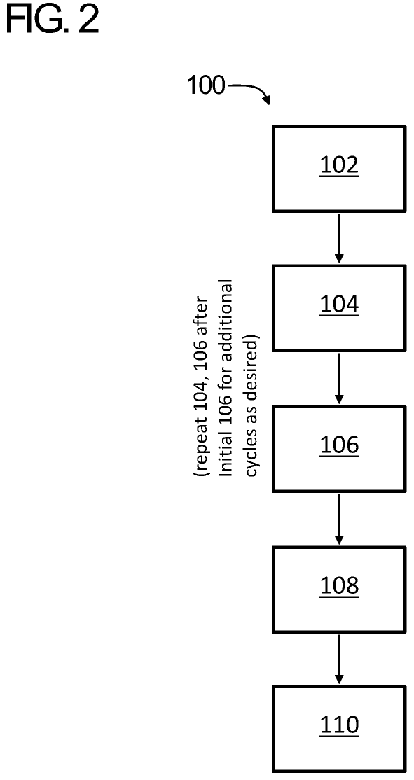

FIG. 2 refers to steps that may be taken to infuse a food grade oil with compounds from a first food to complete step 100 of FIG. 1. Suitable food grade oils for this process include, but are not limited to, coconut oil, medium chain triglycerides (MCT) oil, vegetable oil, sunflower oil, olive oil, grape seed oil, avocado oil, and combinations thereof. Likewise, shortening, margarine, or lard may be used in the process.

In one embodiment as shown in FIG. 2, whole or parts of a given first food can be used in the process, depending on the desired infusion effects. Some parts of a particular food may have a higher concentration of a desired, specific compound or compounds, such that the most effective infusion occurs with a part of a raw food. For example, in the instance where the first food is jalapeno peppers, it might be desirable to use just the flesh of the pepper without the seeds to achieve a desired jalapeno flavoring in a second food, such as popcorn kernels.

Virtually any type of food amenable to the manipulations in the presently described method(s) can be used as a first, compounds releasing food or a second, compounds receiving/infused food. In addition to use of a first food, the presently disclosed method(s) can also be performed with a food extract. In this manner, an extract can be added to the infusion food grade oil in a first overall step to generate an extract infused oil. The extract infused oil, dairy product, or water is then used in a second overall step to infuse a recipient food consumable with the extract. For example, a cinnamon extract can be added to a food grade oil such as coconut oil to generate a cinnamon infused coconut oil. That oil in turn can be used to infuse a food, for example, popcorn kernels to generate cinnamon infused popcorn kernels.

As shown in (at 102), a suitable food grade oil such as coconut oil, MCT oil, another similar oil as described above, a combination of coconut oil and MCT oil, or a combination of two or more similar oils as described above, is heated to a temperature equal to or between about 170° and 240° F. For the purposes of this specification, the term “about” used in relation to temperatures will mean within ±1%. Regarding a combination of coconut oil and MCT oil, a preferred embodiment is to use a ratio of 75% coconut oil to 25% MCT oil. Alternatively, ratios of coconut oil to MCT oil can range from virtually any ratio of the two oils, from 99% coconut oil:1% MCT to 1% coconut oil: 99% MCT oil.

Next (at 104), the first food material (whole or parts of a food) is added to the food grade oil and held at the temperature between 170° and 240° F. for 4-12 hours, while occasionally (or continuously) stirring the mixture. The food material can be food material as a whole, or food material that is sliced, chopped, diced, ground, and so forth. In some embodiments, the ratio of food material to food grade oil is 1 lb. food material to 2 gallons oil. However, other ratios within 10%, 20%, 30%, 40%, 50%, 75%, 100% of this ratio also may be used. In general, the ratio will be chosen to provide high levels/concentration(s) of food compounds within the food grade.

After the heating step of 104, in the next step (at 106), the first food material and food grade oil mixture is frozen to obtain a solid, frozen biomass of first food material and food grade oil mixture.

At this juncture, the solid, frozen biomass of first food material and food grade oil can be processed in one of several ways. First, the frozen biomass can be heated and strained as per steps 108 and 110 (below) to yield a first food compounds infused food grade oil produced by a single cycle or phase of heating and freezing. Second, the frozen biomass alternatively can be treated with a second cycle or phase of heating and freezing, in which steps 104 and 106 are repeated, followed by subsequent steps 108 and 110 to yield a first food compounds infused food grade oil produced by two cycles of heating and freezing. Third, the second cycle treatment can be followed by a third cycle or phase of heating and freezing, in which steps 104 and 106 are repeated, followed by subsequent steps 108 and 110 to yield a first food compounds infused food grade oil produced by three cycles of heating and freezing.

A single cycle/phase treatment typically will produce a first food compounds infused food grade oil having a lesser relative level of infused first food compounds compared to a double cycle/phase treatment that will typically yield a greater level of infused first food compounds. For some particular applications, a third cycle treatment may yield an even greater level of infused first food compounds than a single or double cycle treatment.

Following step 106, at step 108, the solid, frozen first food and food grade oil biomass is reheated to 100° to 240° F. and held at the temperature for a sufficient period of time to liquify the mixture, typically for about 2-4 hours.

Next (at 110), the first food and food grade oil mixture is strained using a press bag (or other suitable straining techniques) to separate the first food compounds infused food grade oil from the first food biomass.

This method results in a whole spectrum first food compounds infused food grade oil that may be used for infusing second food consumables, as described below.

To generate an infused food grade oil with a food extract, the food extract is added directly to the infusion carrier without the heating and freezing steps described above and outlined in FIG. 2.

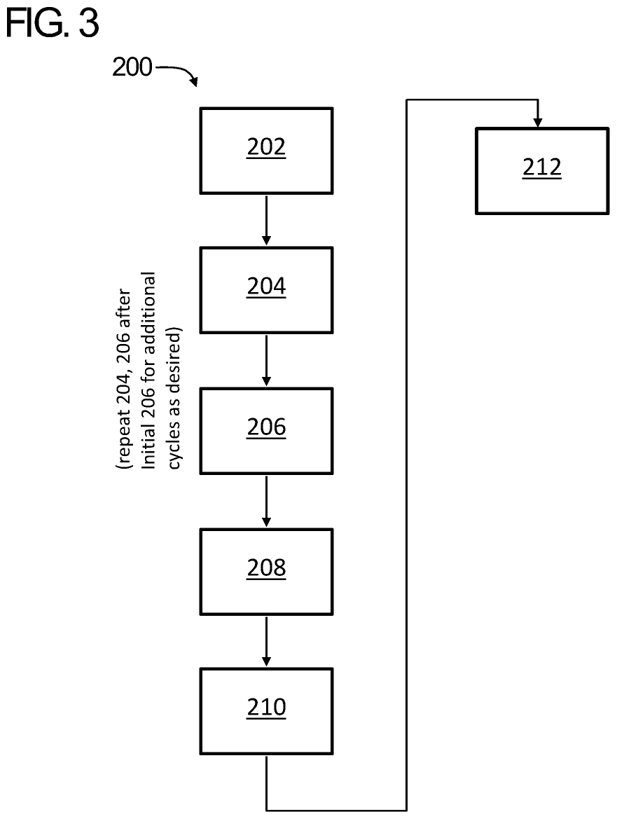

In another embodiment as shown in FIG. 3, a first food compounds infused food grade oil such produced by process 102-110 (FIG. 2) described above, is used to infuse second food consumables with whole spectrum compounds from the first food.

First (at 202), at least a portion of the first food compounds infused food grade oil obtained from 102-110 (FIG. 2) is heated to a first temperature between about 170° F. and 240° F.

Next (at 204), a selection of second food consumables, is added and stirred into the mixture (preferably with continuous stirring) and held at the first temperature of about 170° F. to 240° F. for about 4-12 hours (in a preferred embodiment, 5-6 hours). For the purposes of this specification, the term “about” used in relation to periods of time will mean±3%.

Next (at 206), the mixture of the second food consumable and infused food grade oil is frozen into a solid, frozen biomass.

At this juncture, the solid, frozen biomass of infused food grade oil and second food consumable can be processed in one of several ways. First, the infused oil and consumable can be heated, strained, and frozen or packaged as per steps 208, 210, and 212 (below) to yield a second food consumable infused with compounds from a first food produced by a single round or phase of heating and freezing. Second, the food grade oil and consumable alternatively can be treated with a second cycle or phase of heating and freezing, in which steps 204 and 206 are repeated, followed by subsequent steps 208, 210, and 212 to yield a first food compounds infused second food consumable produced by two cycles of heating and freezing. Third, the second cycle treatment can be followed by a third cycle or phase of heating and freezing, in which steps 204 and 206 are repeated. Following a third cycle, the frozen biomass can be heated and strained as per steps 208 and 210 to yield a first food compounds infused second food consumable produced by three cycles or phases of heating and freezing.

A single cycle/phase treatment typically will produce a first food compounds infused consumable having a lesser relative level of infused first food compounds compared to a double cycle/phase treatment that will typically yield a greater level of infused first food compounds. For some particular applications, a third cycle treatment may yield an even greater level of infused first food compounds than a single or double cycle treatment.

Following step 206, at step 208, the mixture including the now infused consumable and infused food grade oil is heated to a temperature equal to or between 100° F. and 240° F. and held at the temperature for a sufficient period of time to liquify the oil, typically about 2-4 hours, and preferably for about 2 hours.

After this heating step at 208, the mixture is strained at step 210 (using any suitable straining technique) and the first food compounds infused second food consumables are removed from the food grade oil.

Then (at 212), the first food compounds infused consumables typically are frozen and stored frozen for subsequent use/packaging/consumption.

This process 202-212 (FIG. 3) results in a second food consumable infused with whole spectrum compounds from a first food. The second food consumable can be referred to as a first food compounds infused consumable.

The freezing step at 206 provides pressure to the consumable that typically deepens the physical depth of the first food compounds infusion into the consumables. For example, in some embodiments, the freezing step at 206 causes the first food compounds to be pressed 10%, 20%, 30%, 40%, 50%, 60%, 70%, 80%, 90% and/or 100% to the centers of the infused consumable.

It is understood that the acts described above are meant as a general overview and demonstration of an exemplary method, and that the method may include different and/or additional acts as described herein or otherwise.

While the present invention has been described as having particular configurations disclosed herein, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

It is understood that any aspect and/or element of any embodiment of the method(s) described herein or otherwise may be combined in any way to form additional embodiments of the method(s) all of which are within the scope of the method(s).

It should be appreciated that the words “first,” “second,” and so on, in the description and claims, are used to distinguish or identify, and not to show a serial or numerical limitation. Similarly, letter labels (e.g., “(A)”, “(B)”, “(C)”, and so on, or “(a)”, “(b)”, and so on) and/or numbers (e.g., “(i)”, “(ii)”, and so on) are used to assist in readability and to help distinguish and/or identify, and are not intended to be otherwise limiting or to impose or imply any serial or numerical limitations or orderings. Similarly, words such as “particular,” “specific,” “certain,” and “given,” in the description and claims, if used, are to distinguish or identify, and are not intended to be otherwise limiting.

It will be appreciated that variations to the embodiments of the invention can be made while still falling within the scope of the invention. Alternative features serving the same, equivalent or similar purpose can replace features disclosed in the specification, unless stated otherwise. Thus, unless stated otherwise, each feature disclosed represents one example of a generic series of equivalent or similar features.

Use of exemplary language, such as “for instance”, “such as”, “for example” (“e.g.,”) and the like, is merely intended to better illustrate the invention and does not indicate a limitation on the scope of the invention unless specifically so claimed.

While the invention has been described in connection with what is presently considered to be the most practical and preferred embodiments and is further described in the examples below, it is to be understood that the invention is not to be limited to the disclosed embodiment, but on the contrary, is intended to cover various modifications and equivalent arrangements included within the spirit and scope of the appended claims.

### Example I: Infused Coffee Beans

First food compounds infused roasted coffee beans may be made by infusing roasted coffee beans with a first food compounds infused food grade oil obtained as described above and outlined in FIG. 2.

In a preferred embodiment, cacao compounds infused roasted coffee beans may be made by infusing roasted coffee beans with a cacao compounds infused oil as described in the process 202-212 (FIG. 3). The heating steps described in the process 202-212 (FIG. 3) for infusing roasted coffee beans are typically carried out at a temperature between 175° F. and 185° F. Once the cacao compounds infused roasted coffee beans are obtained, they can be stored frozen to help preserve freshness and slow/prevent deterioration of the cacao compounds that reduces the efficacy of the compounds. The cacao infused roasted coffee beans can be used to make a cacao compounds infused coffee beverage(s). In other words, a cacao flavored coffee. In addition to cacao beans infusion, coffee beans can be infused with wide variety of foods and compounds to obtain different flavors. Such food include, but are not limited to, fruit and nuts.

### Example II: Flavored Cacao Beans

The process(es) described herein can be used, for example, to generate fruit, nut, and mint flavored cacao beans. Examples of such flavored cacao beans include, but are not limited to, orange, cherry, apricot, mango, strawberry, almond, pistachio, walnut, cashew, peanut, mint, and so forth. The process by which cacao beans are infused and flavored with various food compounds follows the processes described above and outlined in FIGS. 2 and 3. Once the food compounds infused cacao beans are obtained, they can be stored frozen to help preserve freshness and slow/prevent deterioration of the food compounds and flavorings.

The food compounds infused and flavored cacao beans can be processed in any of a variety of methods similar to standard cacao beans (which are not infused) to produce infused, flavored cacao and chocolate products, such as but not limited to, hot chocolate beverage, chocolate chips, chocolate bars, chocolate bars with nuts and fruit, chocolate bars with nougat, and so on.

### Example III: Flavored Popcorn

Food compounds infused and flavored popcorn kernels may be made by infusing popcorn kernels with an infused food grade oil obtained as described above and outlined in FIG. 2.

In a preferred embodiment, popcorn kernels are infused with a first food compounds with an infused coconut oil, to which raw kernels are added to the infused coconut oil at a temperature between 150° F. and 200° F. (preferably 170° F.) in the process described above and in FIG. 3. Popcorn can be infused with a wide variety of flavors in this manner, such as, but not limited to, jalapeno and other peppers, cinnamon and other extracts, fruit (mango, cherry, apricot, etc.), cacao beans, coffee beans, nuts (almonds, walnuts, pistachios, cashews, peanuts, etc.), seeds, vegetables, and so forth.

The infused kernels can then be used directly for popcorn or can be stored. Infused kernels that are to be used directly for popcorn are typically stored in a cooking oil, typically at about a 1:1 kernels to oil ratio. The infused kernels can then be popped directly from the stored mixture.

### Example IV: Infused Dehydrated Fruit

The process by which dehydrated fruit is infused with a first food compounds follows the process described above and outlined in FIGS. 2 and 3. Once the food compounds infused dehydrated fruit is obtained, it can be stored frozen to help preserve freshness and slow/prevent deterioration of the infused compounds.

Virtually any dehydrated fruit can be used in the foods compounds infusion process, such as, but not limited to, dehydrated strawberries, other berries, cherries, apricots, mangos, grapes (raisins), cranberries, prunes, and so forth. The fruit can be infused and flavored with a wide variety of foods, such as, but not limited to, cacao beans, coffee beans, jalapenos and other peppers, extracts (such as cinnamon, almond, rum, etc.), other fruits, nuts (almonds, walnuts, pistachios, cashews, peanuts, etc.), seeds, and so on. Once the infused and flavored dehydrated fruit is obtained, the fruit can be stored frozen to help preserve freshness and slow/prevent deterioration of the infused food compounds. The infused dehydrated fruit can be consumed directly or used in the preparation of various foods that contain dehydrated fruit, such as trail mix, granola bars, chocolate bars, baked goods, and the like.

### Example V: Infused Raw Fruit

The process by which raw fruit is infused with food compounds generally follows the process described above and outlined in FIGS. 2 and 3, with some modifications. In a preferred embodiment, MCT oil is used as the infused oil is used, given its relatively low melting/liquifying temperature.

To infuse raw fruit, the raw fruit is mixed with the food compounds infused oil at a temperature between about 100° F. and 150° F. for 15 minutes to one hour. The mixture of infused oil and fruit is then frozen solid. Following the freezing, the mixture is liquified at a temperature between about 100° F. and 150° F. and then the fruit is separated from the oil using an acceptable straining method, such as straining through a nylon mesh filter. Preferably, the type of raw fruit used in this process has a relatively high density that helps keep the fruit intact throughout the process. For example, pineapple and mango are fruits that have been used in this process to produce food compounds infused and flavored pineapple and mango. The fruit can be infused and flavored with a wide variety of foods, such as, but not limited to, cacao beans, coffee beans, jalapenos and other peppers, extracts (such as cinnamon, almond, rum, vanilla, etc.), other fruits, nuts (almonds, walnuts, pistachios, cashews, peanuts, etc.), seeds, and so on. The infused fruits can be stored frozen to help preserve the integrity of the first food compounds. The fruits can be consumed directly or used in other foods, such as the aforementioned chocolate and granola bars.

### Example VI: Infused Raw and Roasted Nuts and Seeds

First food compounds infused raw or roasted nuts and seeds may be made by infusing raw or roasted nuts and seeds with a first food compounds infused oil obtained as described above and outlined in FIG. 2.

To infuse raw nuts and seeds or roasted nuts and seeds with first food compounds from an infused food grade oil, the consumables are added to infused oil at a temperature between 150° F. and 200° F. (preferably 170° F.) in the process described above and in FIG. 3. The nuts can be infused and flavored with a wide variety of food compounds, including, but not limited to, those from jalapeno and other peppers, cinnamon and other extracts, fruit (mango, cherry, apricot, etc.), cacao beans, coffee beans, other nuts (almonds, walnuts, pistachios, cashews, peanuts, etc.), seeds, and so forth. The infused nuts and seeds can then be consumed directly or used in other foods, such as chocolate and granola bars, trail mix, and so forth.

### Example VII: Granola Bars

Granola bars infused with compounds from a first food can be made using suitable food compounds infused oils as infused using the infusion process described above and outlined in FIG. 2.

Once a suitable food compounds infused oil is produced, the infused oil can be used as a base for granola bars. The bars likewise can be made with a variety of food compounds infused nuts and/or seeds that are formed into granola bars with oatmeal (that likewise can be infused with food compounds) or a similar foodstuff that is commonly used in granola bars. Such granola bars formed in this manner can contain a significant number of food compounds.

### Example VIII: Infused Trail Mix

Trail mix can be made from food consumables that have been infused with compounds from a first food/foods. As described above, dehydrated fruit, raw and roasted nuts and seeds, cacao beans, and coffee beans can all be infused and flavored using the processes detailed above. Accordingly, trail mix can be made to include one or more infused foods, such as one or more types of infused dehydrated fruit, one or more types of infused nuts and seeds, cacao beans, and so forth. In this manner, trail mix can be made with infused flavors.

### Example IX: Infused Baked Goods

As detailed above, first food compounds infused food grade oils can be produced by the methods disclosed herein. Such infused oils can in turn be used to make various baked goods, such as cookies, brownies, quick breads, cake, and so forth. In this regard, first food compounds infused oils can be added as a base ingredient for baked goods, such as the food grade oil used in baked goods or in combination with other base ingredients, such as butter. In one exemplary embodiment, a ratio of 75% food compounds infused oil to 25% food compounds infused butter is used as a base ingredient in making cookies, brownies, cake, and other baked goods.

In addition to using infused oils as a base ingredient to achieve infused baked goods, such baked goods can further contain other infused ingredients. As described above, dehydrated fruit, raw and roasted nuts and seeds, cacao beans, and coffee beans can all be infused and flavored using the processes detailed above. Accordingly, baked goods can be made to include one or more infused foods, such as one or more types of infused dehydrated fruit, one or more types of infused nuts and seeds, cacao beans (or chocolate made from flavored cacao beans), and so forth. In this manner, baked goods can be made with infused flavors for both base and other ingredients.

### Example X: Infused Rice and Beans

Food compounds infused rice or beans (such as pinto beans, navy beans, and other similar beans) can be made using following the general process described above and outlined in FIGS. 2 and 3. The heating steps described in the process 202-212 (FIG. 3) for infusing rice or beans is typically carried out at a temperature between 150° F. and 170° F. for 3-4 hours. Once the food compounds infused rice or beans are obtained, the rice or beans can be stored frozen to help preserve freshness and slow/prevent deterioration of the food compounds.

### Example XI: Infused, Flavored Oil

As detailed above, food compounds infused food grade oils can be produced using essentially all food grade oils and butter, including but not limited to, coconut oil, butter, MCT oil, shortening, lard, vegetable oil, sunflower oil, olive oil, grape seed oil, avocado oil, and combinations thereof. Any of these oils and butter can be infused with food compounds using the oil infusion process described above and outlined in FIG. 2. Food infused oils and butter can be used to infuse various consumables by the methods described above and outlined in FIG. 3 as well as in the various specific examples described above. The methods described herein may also be used to produce infused cooking flavoring agents, such as herbs and spices. Such food compound infused, flavoring agents (herbs and spices) can be used on food to provide food compounds and flavor. The flavored, food compounds infused oils also can be used to impart flavors and compounds to other foods in several ways, such as, but not limited to, by directly using the infused oil on food, as a cooking oil, in the infusion methods disclosed herein, and so forth.

Another aspect of the infused compounds oil is that the oil typically acquires/takes on flavor from the infused consumable when the infused oil is used in the methods described above and outlined in FIG. 3. For example, a cacao beans infused oil that is used to infuse coffee beans (with compounds from cacao beans) will acquire coffee beans flavor in the residual oil following the infusion. The residual, flavored, food compounds infused oils can be used to impart flavors and food compounds to other foods in several ways, such as, but not limited to, by directly using the infused oil on food, as a cooking oil, in the infusion methods disclosed herein, and so forth.

### Example XII: Ice Cream, Jams, and Jellies with Infused Fruit

As detailed above, food compounds infused fresh and dehydrated fruits can be produced by methods disclosed herein. Such food compounds infused and flavored fruits can in turn be used in ice cream, jams, and jellies to produce food compounds infused, flavored ice cream, jams, and jellies. For example, food compounds infused fresh fruit can be used to make a slurry that in turn can be used in making ice cream, jams, or jellies, resulting in food compounds infused and flavored ice cream, jams, or jellies. The food compounds content of such products can be increased by adding other food compounds infused consumables, such as food compounds infused nuts and/or chocolate.

### Example XIII: Infused Freeze-Dried Consumables

As detailed above, food compounds infused food grade oils can be produced by the methods disclosed herein. Such infused oils can in turn be used to make a wide variety of various food infused consumables, such as infused raw fruit, ice cream, and so forth. A wide variety of food compounds infused consumables can in turn be treated by the process of lyophilization, commonly known as freeze-drying, to turn the food compounds infused consumables into another form of consumable. Lyophilization typically removes 98% of the original water content, typically resulting in a crunchy and/or creamy consumable. Accordingly, the methods described herein can be applied to produce food compounds infused consumables that in turn are freeze-dried to produce freeze-dried food compounds infused consumables. The freeze-drying process allows foods such as infused fruit to retain both its infused food compounds and its nutrition.

### Example XIV: Pressure Cooked Food Compounds Infused Consumables

As detailed above, food compounds infused food grade oils can be produced by the methods disclosed herein. Such infused oils can in turn be used to make a wide variety of various food compounds infused consumables by methods that include heating and freezing steps to infuse the consumables with food compounds, as described above. In an exemplary embodiment, the heating steps may be carried out under pressure, such as in a pressure cooker. In this regard, the levels of infused food compounds in an infused consumable produced with pressure cooking can be greater than the relative levels obtained without pressure cooking. Accordingly, pressure cooking, or similar pressurized heating can be used to produce consumables that have even higher levels of infused food compounds when compared to the infused consumables produced by the methods disclosed herein.

What is claimed is:

1. A method of infusing a food grade oil with whole spectrum food compounds, the method comprising:
(A) providing a food material;
(B) providing a food grade oil at a temperature of 170° F.-240° F.;
(C) adding at least a portion of the food material of (A) to the oil of (B) to form a food material and food grade oil mixture;
(D) heating the food material and food grade oil mixture of (C) to a temperature of 170° F. −240° F. for 4-9 hours;
(E) freezing the food material and food grade oil mixture of (D) into a solid, frozen biomass;
(F) heating the solid, frozen biomass of food material and food grade oil mixture of (E) at a temperature of 150° F.-240° F. for 2-4 hours; and
(G) straining the food material and food grade oil mixture of (F) to separate the food grade oil from the food material to yield food grade oil infused with whole spectrum food compounds.

2. The method of claim 1, further comprising: repeating steps (D) and (E) one or more times before step (F).

3. The method of claim 1, wherein the food grade oil provided in (B) is selected from the group consisting of coconut oil, medium chain triglycerides oil, vegetable oil, sunflower oil, olive oil, grape seed oil, avocado oil, butter, shortening, margarine, lard, and a combination thereof.

4. The method of claim 1, wherein the food grade oil provided in (B) is coconut oil.

5. The method of claim 1, wherein the food grade oil provided in (B) is medium chain triglycerides oil.

6. The method of claim 1, wherein the food grade oil provided in (B) is a combination of coconut oil and medium chain triglycerides oil.

7. The method of claim 1, wherein the food material in (A) is obtained from the group consisting of coffee beans, cacao beans, raw nuts and seeds, jalapeno peppers, peppers, raw fruit, garlic, bacon, and combinations thereof.

8. A method of infusing an orally ingestible consumable with whole spectrum food compounds, the method comprising:
(A) providing a food material;
(B) providing a food grade oil at a temperature of 170° F.-240° F.;
(C) adding at least a portion of the food material of (A) to the oil of (B) to form a food material and food grade oil mixture;
(D) heating the food material and food grade oil mixture of (C) to a temperature of 170° F. −240° F. for 4-9 hours;
(E) freezing the food material and food grade oil mixture of (D) into a solid, frozen biomass;
(F) heating the solid, frozen biomass of food material and food grade oil mixture of (E) at a temperature of 150° F.-240° F. for 2-4 hours;
(G) straining the food material and food grade oil mixture of (F) to separate the food grade oil from the food material to yield a whole spectrum food compounds infused food grade oil;
(H) adding at least one orally ingestible consumable to the whole spectrum food compounds infused food grade oil of (G) to form a consumable and infused oil mixture;
(I) heating the consumable and infused oil mixture of (H) to a temperature of 170° F.-240° F. for 4-9 hours;
(J) freezing the consumable and infused oil mixture of (I) to form a solid, frozen mixture of consumable and infused oil;
(K) heating the solid, frozen mixture of consumable and infused oil of (J) to a temperature of 150° F.-200° F. for 2-4 hours to liquify the infused oil; and
(L) straining the consumable from the infused oil of (K) to yield a consumable infused with whole spectrum food compounds.

9. The method of claim 8, further comprising: (M) freezing the infused consumable of (L).

10. The method of claim 8, further comprising: repeating steps (D) and (E) one or more times before step (F).

11. The method of claim 8, further comprising: repeating steps (I) and (J) one or more times before step (K).

12. The method of claim 8, further comprising: repeating steps (D) and (E) one or more times before step (F); and
repeating steps (I) and (J) one or more times before step (K).

13. The method of claim 8, wherein the food grade oil provided in (B) is selected from the group consisting of coconut oil, medium chain triglycerides oil, vegetable oil, sunflower oil, olive oil, grape seed oil, avocado oil, butter, shortening, margarine, lard, and a combination thereof.

14. The method of claim 8, wherein the food grade oil provided in (B) is coconut oil.

15. The method of claim 8, wherein the food grade oil provided in (B) is medium chain triglycerides oil.

15. The method of claim 8, wherein the food grade oil provided in (B) is a combination of coconut oil and medium chain triglycerides oil.

16. The method of claim 8, wherein the food material in (A) is obtained from the group consisting of coffee beans, cacao beans, raw nuts and seeds, jalapeno peppers, peppers, raw fruit, garlic, bacon, and combinations thereof.

17. The method of claim 8, wherein the orally ingestible consumable in (H) is obtained from the group consisting of coffee beans, cacao beans, tea leaves, raw vegetables, raw nuts and seeds, roasted nuts and seeds, popcorn kernels, corn kernels, potatoes, dehydrated fruit, raw fruit, beans, rice, and noodles.

18. The method of claim 8, wherein the orally ingestible consumable in (H) is coffee beans.

19. The method of claim 8, wherein the orally ingestible consumable in (H) is cacao beans.

20. The method of claim 8, wherein the orally ingestible consumable in (H) is popcorn kernels.
